(19) United States
(12) Patent Application Publication
(10) Pub. No.: US 2017/0261749 A1
(43) Pub. Date: Sep. 14, 2017

(54) IMAGE PROJECTOR WITH SCREEN AND LIGHT SOURCE EMPLOYING LIGHT-EMITTING QUANTUM RODS

(71) Applicant: VALEO VISION, Bobigny Cedex (FR)

(72) Inventors: Gilles BRIAND, Mougins (FR); Gilles Le-Calvez, Rueil-Malmaison (FR)

(73) Assignee: VALEO VISION, Bobigny Cedex (FR)

(21) Appl. No.: 15/455,162

(22) Filed: Mar. 10, 2017

(30) Foreign Application Priority Data
Mar. 11, 2016 (FR) 16 52081

(51) Int. Cl. G02B 27/01; B60K 35/00

(52) U.S. Cl. CPC G02B 27/0149; G02B 27/0172; G02B 27/0176; G02B 27/0101; B60K 35/00; G02B 2027/0178; G02B 2027/0118; B60K 2350/1072; B60K 2350/2052; B60K 2350/921

(57) ABSTRACT

The present invention relates to a display system including a screen, an image projector including a light source including light-emitting quantum rods configured to emit a luminous pattern, wherein the projector and the screen cooperate to form a virtual image of the luminous pattern by means of the screen.

The present invention concerns a system for projecting images onto an at least partly transparent screen, notably a motor vehicle screen and/or a screen intended to be mounted in a vehicle.

There are known systems including a screen inside which information is displayed. For example, in motor vehicles there are known transparent plates extending from the dashboard and inside which images are displayed. These systems often display only a basic image or employ bulky devices.

The technical problem that the invention aims to solve is therefore to improve the performance of a system making it possible to display an image relative to a screen by improving the capacity of that system to display an image with more details whilst having a limited or even small overall size.

To this end, the invention consists firstly in a display system including:
an at least partly transparent and at least partly reflective screen,
an image projector including a light source including submillimetre-size light-emitting quantum rods, the quantum rods being configured to emit a luminous pattern.

In said display system according to the invention the image projector and the screen cooperate to form a virtual image of the luminous pattern by means of the screen.

By exploiting in this way a light source with submillimetre-size light-emitting quantum rods, it is possible to produce a luminous pattern including different details and of higher resolution whilst employing a light source of reduced size compared to other light sources such as LEDs or LCD screens. The projector can therefore be of smaller size and the display system less bulky.

This light source is referred to hereinafter as a quantum rod light source.

The image projector makes it possible to house the light source at a distance from the screen. This therefore offers greater freedom to adapt the system to the environment into which it is to be incorporated, for example a vehicle passenger compartment.

Moreover, the use of the screen to form the virtual image makes it possible for an observer to observe that virtual image when looking through that screen. The latter image will not be displayed directly at the level of the screen but in front of it. This also offers greater freedom of arrangement because the screen does not have to be positioned where the image is to be observed, unlike a standard screen onto which a source image is projected, for example.

Here the source image is a light spot or image that is actually sent to a given location.

According to one embodiment of the invention, the image projector includes optical elements adapted to project the source image from the light source. Projection by means of optical elements is a simple way to produce an observable pattern. The latter pattern will in fact correspond to the luminous pattern from the light source. Moreover, depending on the arrangement of the system, this can make it possible to produce a source image larger than the quantum rod light source without adversely affecting the compactness of the system.

The display system according to the invention may optionally have one or more of the following features:
the image projector is adapted to send a source image of the luminous pattern onto the screen; this is a simple embodiment;
the virtual image is formed in front of the screen; this is useful in some embodiments, notably in situations where the screen is a spectacle lens;
the screen has a light transmission coefficient of at least 20%;
the image projector includes optical elements adapted to project the source image from said light source; this is a simple and compact embodiment making it possible to form an image from a pattern;
the optical elements and the light source are such that the direction of emission of light by the light source is transverse, notably approximately perpendicular, to the normal to an edge surface of the screen through which the light rays leaving the image projector enter; the length of the image projector can therefore extend transversely relative to the screen;
the screen includes Bragg mirrors, the image projector and the screen being such that the virtual image is formed by reflection of rays coming from the source image by these Bragg mirrors; this makes possible better reflectivity and therefore makes it possible to limit the power of the energy source supplying power to the image projector;
the image projector is adapted to send the source image in a direction at an angle greater than 45° to the normal to the screen; this improves the compactness of the system;
the screen has two extended faces separated by an edge surface, the image projector being adapted to direct the light rays forming the source image toward that edge surface, the screen including decoupling elements and being such that these light rays propagate within the thickness of the screen as far as decoupling elements that deflect the light rays out of the screen through one of its extended faces; the image is therefore propagated by internal reflection and the image projector can be near the screen;
the quantum rods are distributed in different luminous zones arranged to form the luminous pattern; this makes it possible to confer a certain resolution on the source image;
the luminous zones can be activated selectively; this makes it possible to modify the images displayed with the same light source, or even to display an animated image;
the luminous zones are distributed in luminous groups, each of these groups including at least two luminous zones, and in each luminous group each luminous zone is adapted to emit light rays of a colour different from that of the light rays that the other luminous zones of that luminous group are adapted to emit; it is therefore possible to have very precise images with a good resolution;
the arrangement of the luminous zones in each of the luminous groups is identical; this facilitates control, in particular selective control, of the luminous zones;
the luminous groups are arranged in the light source in rows and columns, the rows and columns include a number of luminous groups sufficient for at least one pattern of part or the whole of a beam for lighting the road to be produced on the light source;
each of the luminous groups includes only first, second and third luminous zones emitting when supplied with electrical power light rays of red, blue and green colour, respectively; it is therefore possible to control each group as a so-called RGB pixel in which first, second and third luminous zones are turned off or turned on with greater or lesser intensity to confer the required colour on the RGB pixel; the system can therefore form colour images;
the system includes a device for controlling the light source, notably in situations where the system includes a pair of goggles as referred to above, the control device being adapted to select and to activate the luminous zones as a function of a received signal so as to form a luminous pattern associated with that received signal;
the control device includes a memory containing a data bank of images associated with codes so that when the received signal corresponds to one of those codes the control device activates the light source so as to form the luminous pattern associated with that code;
the screen is a vehicle screen; this therefore makes it possible to display information intended for the driver or a passenger looking through the screen;
the screen is chosen from: a windshield, a partially transparent plate extending from the top of the dashboard, an instrument screen of the dashboard or a rear window of the vehicle; this makes it possible for the driver in particular to have additional information in their field of view;
the system includes a vision device including said screen and at least one retaining element supporting said screen, the retaining element or elements being adapted to retain the vision device on the head of a user, notably by placing the retaining means on their head, so that the screen is arranged in front of at least one eye of the user; this makes it possible to use this equipment only for the driver;
the image projector is on the retaining element or one of the retaining elements; this results in a compact device;
the screen has a front face and a rear face separated by an edge surface, the image projector being adapted to direct the light rays forming the source image toward that edge surface, the image projector including coupling elements and being such that these rays propagate within the thickness of the screen as far as decoupling elements that deflect the light rays out of the screen through its rear face; this is one way to produce an image in front of a worn screen that will be visible only to the wearer of the vision device and within their field of view; the coupling elements may for example be formed on the rear diopter and/or the front diopter of a projection lens;
the retaining element includes a device for controlling the light source so as to form the luminous pattern; the display of the information can therefore be controlled as a function of a received signal or an activated control, for example;
the retaining element includes a signal receiver, notably a Bluetooth signal receiver or a Wi-Fi signal receiver, connected to said control device; the display system can therefore receive control signals, for example from a dashboard computer, and display certain information, for example a speed limit pictogram;
the signal receiver and the control device are such that the control device activates the light source as a function of the signal or signals received by said signal receiver;
the vision device is chosen from:
   a helmet the visor of which forms the screen and the protective part of which forms said retaining element,
   a pair of goggles of which at least one lens forms the screen and the frame of which forms said retaining element,
   a vision mask the transparent mask of which forms the screen and the frame of which forms said retaining element,
   a monocular the lens of which forms the screen and the frame of which forms said retaining element.

The invention also consists in a vehicle including a display system according to the invention.

According to one embodiment of said vehicle, the screen is a rear window, said vehicle including an internal rear view mirror at the front that can be seen by the driver, the front rear view mirror, the rear window and said projector being such that the virtual image is visible in the front interior rear view mirror.

The invention also consists in a method of controlling a display system according to the invention.

Moreover, the light source in the display system according to the invention may optionally have one or more of the following features:
the quantum rods have a diameter between 0.1 micrometre (μm) and 2 μm, inclusive, notably between 1.4 μm and 1.6 μm, inclusive, for example 1 μm; this makes it possible to increase the light-emitting area and to confer better light yield on the light source; by the diameter of the quantum rods is meant the diameter of the circle circumscribed on the cross section of said quantum rods, the term “cross section” here meaning a section transverse to the direction in which the corresponding quantum rod extends; for example, these quantum rods may be of polygonal section, notably have a section corresponding to a regular polygon, notably a hexagonal section, the circle circumscribed on that section passing through each apex of the corresponding polygon;
the quantum rods have for example a height between 2 μm and 10 μm inclusive, for example 8 μm; this makes it possible to increase the light-emitting area and to improve the light yield of the light source;
the quantum rods are between 1 μm and 35 μm apart, preferably between 3 μm and 30 μm apart, preferably between 3 μm and 10 μm apart; the maximum distance corresponds to a minimum quantum rod density; although said maximum distance is not limiting on the invention, it yields better results in terms of light yield, namely the ratio of the optical power emitted to the electrical power injected, notably for a motor vehicle lighting module; the minimum 1 μm facilitates the production of said light sources, in particular the growth of the quantum rods; nevertheless, if the quantum rods are too dense, the emission from some quantum rods may be impeded by the presence of other quantum rods around them;
the yield of the light source is significantly improved with a distance of at least 3 μm; the quantum rods extend from the substrate in a preferred direction;
the quantum rods include a metal nitride, notably gallium nitride, and/or the substrate is essentially silicon-based; metal nitrides and in particular gallium nitride make it possible to obtain good results in terms of light emission; silicon makes it possible to produce a light source, and therefore an image projector, that is less costly than standard LEDs;
the light source includes a layer of a luminophore arranged above the quantum rods so that the luminophore receives the rays emitted by the quantum rods and in turn emits light rays corresponding to the light rays emitted by the corresponding luminous zone;
the light source includes connecting means intended to be connected to an electrical power supply, said connecting means being adapted to supply electrical power independently to the various luminous zones; the light source can therefore receive the electrical power supply of the different zones from a single connecting point;
the substrate includes a cathode connected to or forming a negative pole of the connecting means; this is a simple way to connect the light source;
the light source includes at least as many anodes as there are luminous zones, each anode being adapted to be in contact with each of the quantum rods of the same single luminous zone, each anode notably being connected to one or more positive terminals of the connecting means or each forming a positive terminal of the connecting means; this is a compact and simple way to connect each luminous zone, which compactness is further improved if the anodes are connected to the same connecting means;
each anode is formed by a conductive layer deposited on top of the substrate on the same side as the quantum rods and electrically connecting the quantum rods to one another; this is a more compact embodiment of the light source;
the chemical composition of the quantum rods of the at least one luminous zone differs from the chemical composition of the quantum rods of the at least one other luminous zone so that the quantum rods of the at least one luminous zone emit light rays of a different colour than that of the light rays emitted by the quantum rods of the at least one other luminous zone;
each luminous zone includes a layer of a luminophore arranged on top of the quantum rods so that the luminophore receives the rays emitted by the quantum rods and in turn emits light rays corresponding to the light rays emitted by the corresponding luminous zone, at least two luminous zones differing from one another in:
   the chemical composition of their quantum rods,
   the chemical composition of their luminophore layer, and/or
   the thickness of their luminophore layer,
      these embodiments making it possible to obtain with different luminous zones different colours and/or intensities;
at least one luminous zone emits a luminous flux different from at least the luminous flux emitted by another luminous zone;
the luminous zones emitting different luminous intensities have a different density of quantum rods per unit area of substrate and/or are of different sizes relative to one another;
the image projector includes means for controlling the different luminous zones adapted to supply power selectively to the luminous zones as a function of a received control signal; the control means are therefore included directly in the image projector without it being necessary to adapt the support or the device as a whole that receives them; the control means notably consist of an electronic control system.

Other features and advantages of the invention will become apparent on reading the following detailed description of nonlimiting embodiments, for an understanding of which reference should be made to the appended drawings, in which:

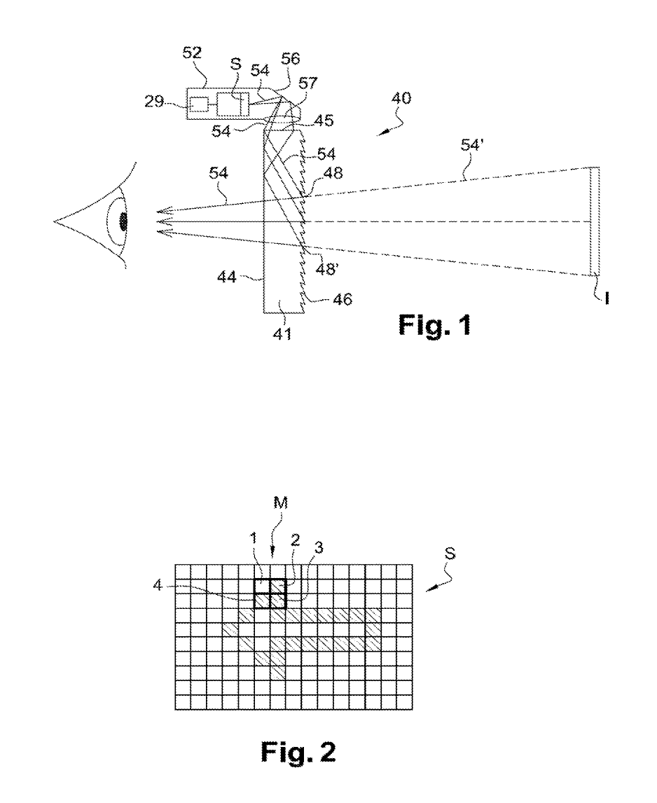

FIG. 1 is a diagram showing an example illustrating the general principle of the display system according to the invention;

FIG. 2 shows a quantum rod light source used in a display system according to the invention, notably as in FIG. 1; this is a front view relative to the overall direction of emission of light by said source;

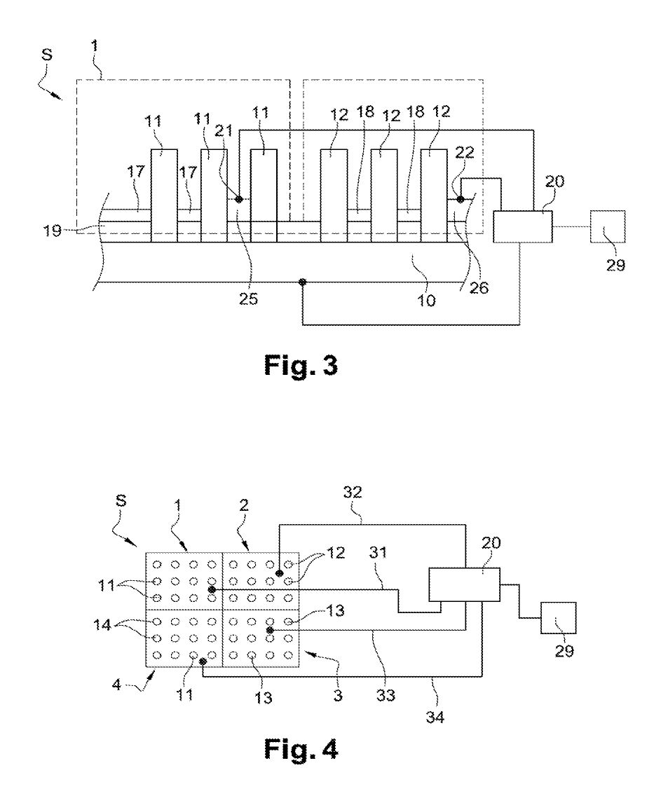

FIG. 3 shows a part of the light source from FIG. 2 seen in section on a plane perpendicular to FIG. 2;

FIG. 4 is a connection diagram of the part of the source represented in FIG. 3 as seen from above;

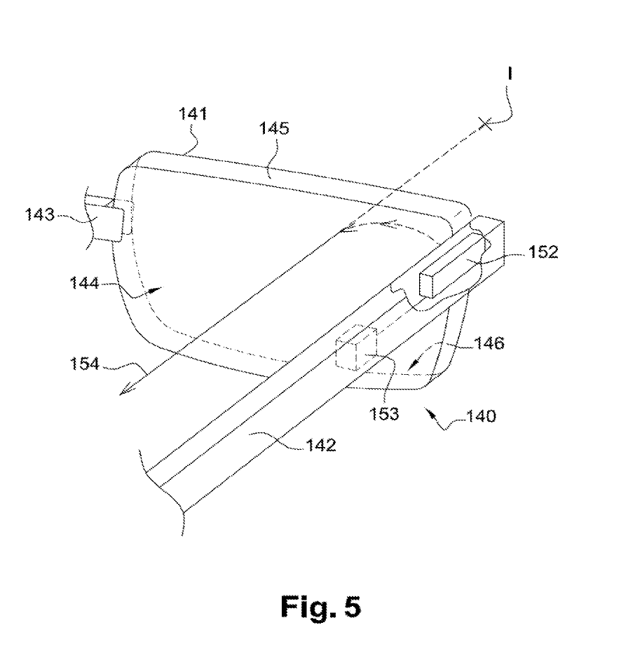

FIG. 5 shows a vision device of a display system according to a first embodiment;

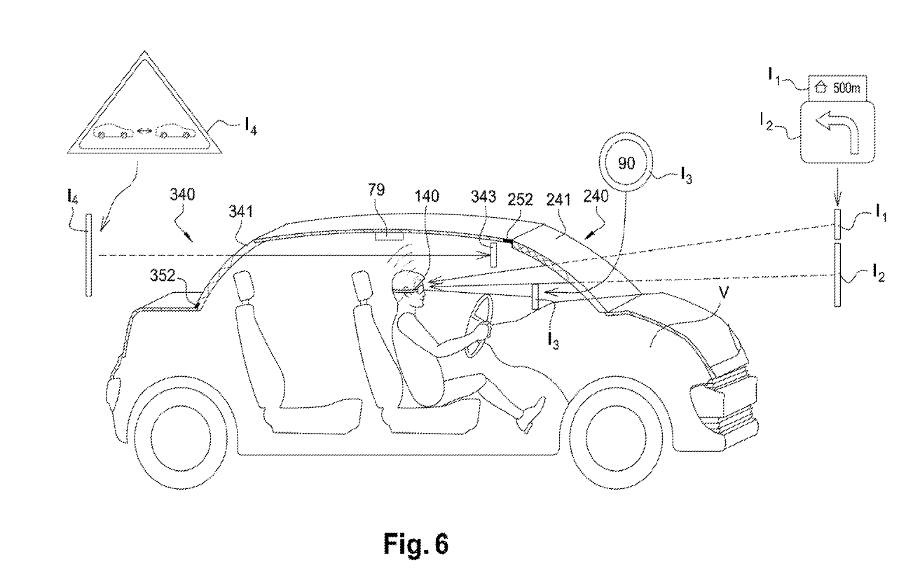

FIG. 6 shows a vehicle with an onboard display system together with the vision device from FIG. 5 and display systems in accordance with second and third embodiments;

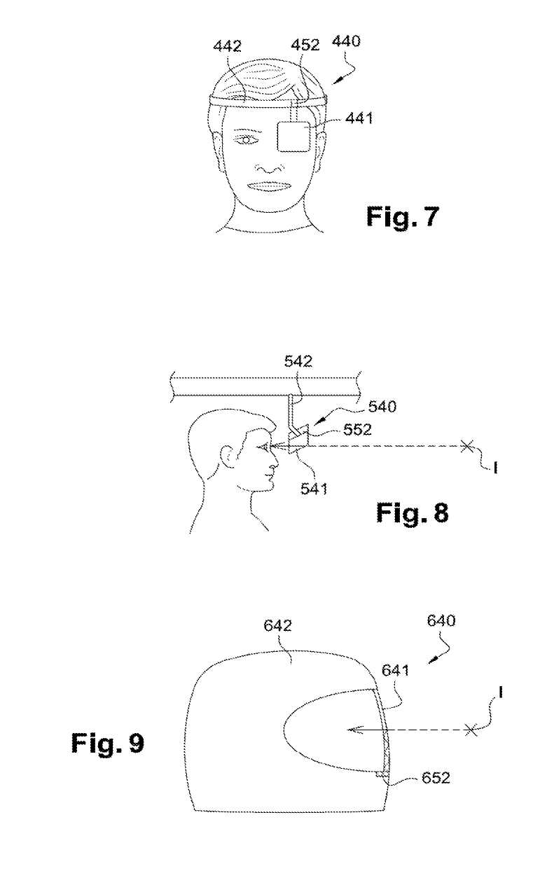

FIG. 7 shows a vision device of a display system according to a fourth embodiment;

FIG. 8 shows a display system according to a fifth embodiment;

FIG. 9 shows a vision device of a display system according to a sixth embodiment.

FIG. 1 shows a display system according to one embodiment of the invention including a device 40 for generating a virtual image. This device includes a screen 41 coupled to an image projector 52. In fact, the image projector 52 is adapted to emit light rays 54 into the screen 41.

This screen 41 is at least partly transparent and at least partly reflective.

The image projector 52 includes a light source S. As shown in FIG. 2, this light source S includes a plurality of luminous zones 1, 2, 3, 4 that can be selectively activated.

In the example shown, these luminous zones 1, 2, 3, 4 are distributed in accordance with a matrix of columns and rows so as to facilitate their selective activation.

The luminous zones 1, 2, 3, 4 can be activated selectively to form a given pattern M.

In the example shown, the various luminous zones represented in black correspond to zones that are turned off whereas the others are turned on. This selective activation confers a configuration of zones that are turned on and turned off corresponding to the given pattern M, in this example a black arrow on a background the colour of the light emitted by the activated luminous zones, for example the colour white.

For clarity, only four luminous zones bear reference numbers here. It can be seen that the first luminous zone 1 is turned on whereas the others 2, 3, 4 are turned off.

As shown in FIG. 1, the image projector 52 includes a control device 29 connected to the light source S and adapted to control it so as to form the luminous pattern M. In this example, this control is effected by selectively turning on or off the luminous zones. It can also modulate the intensity of the light emitted by these luminous zones.

The screen 41 has two opposite extended faces 44 and 46 separated by an edge surface 45.

The light source S is arranged facing a set of optical elements 56, 57 adapted to project an image of this light source in the direction of the edge surface 45 of the screen 41.

In this example this set of optical elements includes at least one projection lens 57 the front and rear diopters of which, relative to the direction in which the rays 54 pass through it, are adapted to direct all of the rays onto the edge surface 45 at an angle such that these rays 54 penetrate into the screen and propagate inside the latter by virtue of one or more internal reflections on its extended faces 44 and 46. This screen 41 is therefore adapted to function as a light guide, its arrangement with the image projector enabling coupling of the light rays 54 within the thickness of the screen 41.

For example, the image projector 52 is adapted to direct the light rays 54 and therefore the source image formed by the pattern M in a direction at an angle less than 10° to the normal to the edge surface 45.

One or both extended faces 44, 46 include(s) coupling elements 48 arranged so that when rays 54 coupled into the screen 31 encounter one of these decoupling elements 48 they are reflected or refracted so as to exit via one of the extended faces of the screen 41, termed the first face or exit face 44.

In this example, the decoupling elements 48 are formed on the extended face opposite the exit face, termed the second face 46. These decoupling elements 48 therefore reflect the rays 54 that encounter them toward the exit face 44 at an angle of incidence such that they exit the screen 41 via the exit face 44.

The decoupling elements 48 can for example be formed by striations that have prism-shaped sections.

The decoupling elements 48 are arranged so that the rays 54 exit the screen 41 in the direction of the location where it is intended that the eye of the user of the display system be positioned.

As in a conventional mirror, these rays 54 correspond to a virtual image I situated on the other side of the screen 41 relative to the user.

Consequently, in the application, the side of the screen 41 facing toward the user is termed the rear side of the screen 41 and the other side relative to the virtual image I is termed the front side of the screen 41.

The observer situated behind the screen 41 will therefore see a virtual image I in front of that screen 41.

This virtual image I is enlarged compared to the image of the luminous pattern M. It is therefore possible to produce a virtual image I at a distance from the screen 41 and of much larger size than the light source S.

Note that according to embodiments of the invention and as shown here the screen 41 and the image projector 52 are arranged so that the exit of the rays from the image projector, here the exit diopter of the lens 57, faces the edge surface 45. In this case the screen can also be arranged so that the image projector 52 directs the source image in a direction at an angle greater than 45° to the normal to the screen. Here the normal to the screen is the normal to a median plane to which the rear face 44 of the screen is the nearest at the shape level. There is therefore an improvement in compactness compared to projectors that project onto conventional screens and in this embodiment the image projector 52 can be very close to the screen 41. In the example shown it is even located at its level.

In this example, the set of optical elements also includes a plane reflector 56 arranged so as to reflect the light rays emitted by the light source S onto the entry diopter of the lens 57. This makes it possible to orient the source S so that it emits in a direction different from the direction of the light rays emitted by the image projector 52.

Here, the light source S is arranged to emit in a direction globally corresponding to a rear to front direction of the screen 41, for example a longitudinal direction in the context of use in a vehicle. The reflector 56 is oriented at 45° to this direction so as to deflect the rays perpendicularly toward the lens 57, which is also arranged longitudinally. This allows a longitudinal arrangement of the image projector 52 and a vertical arrangement of the screen 41, as for example in the case of an image projector in an eyeglasses temple coupled to an eyeglasses lens, as described later.

According to an embodiment that is not shown, the various optical elements of the projector 52 can be chosen to deform to a greater or lesser degree the image of the luminous pattern M. For example, the pattern M may be formed anamorphically relative to the virtual image I. In this case the optical elements are adapted to change the width/length proportions of the virtual image. For example, the pattern M can be of trapezoidal shape but the optical elements are adapted to project a square rendition of it. This notably provides greater freedom in orienting the source relative to the screen.

In other embodiments, as in those shown, the pattern M is deformed little or not at all and only its size is increased after protection as a virtual image I.

The invention exploits a submillimetre-size quantum rod light source S divided into different zones that form the selectively activatable zones 1, 2, 3, 4. The advantage of a light source S of this kind is that the zones that can be activated selectively can be of relatively small size, making it possible for the image projector also to be of small size and easily incorporated in other devices, for example in a device onboard a vehicle.

The virtual image I being a projection in front of the screen 41, it can for example be superposed on some of the objects perceived by the observer through the screen 41. It therefore suffices for the virtual image I to be the size of the object, as it appears in the field of view of the observer. In an example of this kind, this makes it possible to highlight these objects using what is termed augmented reality.

Note however that there may be embodiments in which the virtual image I is displayed without superposition on other objects

The above lighting zones are shown in detail in FIGS. 3 and 4, which are diagrams showing a portion of the quantum rod light source S. As shown in FIG. 2, the light source S includes a substrate 10 from which quantum rods 11, 12, 13, 14 extend in a preferred direction.

In this example in particular, this substrate 10 is made of silicon, which represents a much lower cost than that of conventional LEDs, in which the substrates are made of sapphire. The quantum rods 11, 12, 13, 14 can be produced by crystal growth on this substrate 10.

The quantum rods 11, 12, 13, 14 are quantum rods of a electroluminescent semiconductor material. The quantum rods 11, 12, 13, 14 may for example essentially consist of gallium nitride.

For example, these quantum rods 11, 12, 13, 14 include a semiconductor material core that can be doped with electrons and around which is formed a first semiconductor material layer having electron deficits, in which case this is sometimes referred to as a layer doped with “holes” or positive charges. At the interface of this core and this first layer is formed an intermediate layer in which the electrons and the electron deficits recombine. Thus each quantum rod 11, 12, 13, 14 is an electroluminescent semiconductor element.

A nucleation layer 19 is formed on the substrate 10 and around the quantum rods 11, 12, 13, 14.

Here the quantum rods 11, 12, 13, 14 are approximately 3 μm apart and each has a height measured from the nucleation layer 19 to their top of 8 μm. Their thickness, which here corresponds to the width of the quantum rods in FIG. 1, is 1 μm.

The light source S therefore essentially comprises a substrate 10 forming a plate bristling with a multitude of small submillimetre-size electroluminescent quantum rods 11, 12, 13, 14, i.e. quantum rods the greatest dimension of which is less than one millimetre.

As indicated above, the light source S is divided into a plurality of luminous zones 1, 2, 3, 4 corresponding to a distribution of the set of quantum rods 11, 12, 13, 14.

An electrically conductive layer is deposited between the quantum rods 11, 12, 13, 14 of the same zone 1, 2, 3, 4, electrically connecting those quantum rods to form a distinct anode 25, 26 for each of the luminous zones 1, 2, 3, 4.

The four anodes 25, 26 formed in this way are in contact with the nucleation layer 19, which is itself in contact with the cathode formed by the substrate 10.

Accordingly, by connecting the anodes 25, 26 and the cathode 10 to a power supply it is possible to supply each of the various luminous zones 1, 2, 3, 4 with electrical power independently of the others.

According to one embodiment of the invention, each anode is connected to one or more positive terminals of connecting means 20 intended to be connected to the positive terminal of an electrical power supply (not shown) of a vehicle. Likewise, the cathode 10 is connected to the negative terminal of the connecting means 20. The connecting means therefore enable the supply of electrical power to each of these luminous zones 1, 2, 3, 4.

It is therefore possible to control this light source S by selective activation of its luminous zones 1, 2, 3, 4 via the connecting means 20.

Control can be exercised by dedicated means separate from the image projector or, as in this example, by a control device 29 incorporated in the image projector 52.

In this example, control is exercised directly by a control device 29. The latter device is connected on the one hand to the connecting means 20 and on the other hand to a connector, not shown, of the image projector 52. The connecting means 20 are connected to each anode 25, 26 via electrical conductors 31, 32, 33, 34, notably at a contact point 21, 22.

The control device 29 and the light source S are mounted on the same printed circuit board, not shown. The electrical conductors 31, 32, 33, 34 are formed by electronic tracks on this printed circuit board. Likewise, other electronic tracks connect the connecting means 20 to the control device 29.

The light yield of the luminous zones 1, 2, 3, 4 can be improved by depositing a reflective layer 17, 18 on the nucleation layer 19. For example, this reflective layer 17, 18 is deposited on the nucleation layer 19 before growing the quantum rods, after which holes are produced in this reflective layer 17, 18 and in the nucleation layer before growing the quantum rods 11, 12, 13, 14 on the substrate 10. To improve the light yield, the quantum rods of the luminous areas can have the following features:
a thickness between 1.4 μm and 1.6 μm inclusive, for example 1 μm,
a height between 2 μm and 10 μm inclusive, for example 8 μm,
a distance between quantum rods between 3 μm and 30 μm inclusive, for example 3 μm.

In FIG. 4 only four luminous zones 1, 2, 3, 4 of the light source are shown.

In the example shown in FIGS. 2 to 4, each luminous zone corresponds to a pixel of the source image, i.e. of the pattern M.

In some embodiments of the invention, however, the luminous zones may be distributed in luminous groups, each of those groups including at least two luminous zones and each luminous zone of each of the luminous groups being adapted to emit light rays of a colour different from that of the light rays that the other luminous zones of that luminous group are adapted to emit.

For example, each luminous group is arranged as an RGB system, each group comprising first, second and third luminous zones emitting respectively red, blue and green light rays when supplied with electrical power. This therefore makes it possible to generate a pattern M with different colours.

FIG. 5 shows an example of a display system according to a first embodiment. In this example, the image generation device 40 of the display system is a vision device 140.

This vision device 140 is a pair of eyeglasses. This pair of eyeglasses 140 comprises three holding elements, namely two spectacle temples 142, only the right hand temple being shown, and an element 143 joining the two lenses 141, only the right hand lens 141 being shown.

At least one of the lenses 141 forms a screen 41 as referred to above.

An image projector 152 is housed in one of the temples 142 of the pair of eyeglasses, here the right-hand temple. The image projector 152 is of relatively small size compared to the pair of eyeglasses 140 to enable it to be housed in the temple 142.

The light source S and the various optical elements making it possible to direct light rays into the lens 141 may be produced as shown in FIG. 1, the image projector 152 being arranged beside the lens 41 and not on top of it, however.

The image projector 152 is adapted to direct the light rays 154 emitted by the quantum rod light source S through an edge surface 145 of the lens 141. To this end the image projector 152 faces the edge surface 145 and in particular may include a projection lens facing that edge surface.

As described above, the light rays 154 then propagate by internal reflection or a plurality of successive internal reflections within the thickness of the lens 141 until they encounter the decoupling elements, not shown in FIG. 5, adapted to decouple the light rays from the lens 141 and to cause them to exit via the diopter formed by the rear face 144 of the lens 141 in the direction of the eye of the wearer of the eyeglasses who therefore receives these rays 154 and therefore sees a virtual image I in front of the lens 141 and facing its front face 146.

The right-hand temple 142 carries a signal receiver 153 examples of the operation of which are explained hereinafter. In particular, the pair of eyeglasses 140 may be coupled to different devices of the vehicle in which the wearer of the eyeglasses 140 is located. For example, devices sending information and/or control signals relating to the luminous pattern M to be formed with the quantum rod light source S.

Three embodiments of display systems according to the invention are shown in FIG. 6.

In addition to the display system including the pair of eyeglasses 140, this vehicle V includes two other display systems.

In accordance with a second embodiment, the display system 240 uses as the screen 41 the windshield 241 of the vehicle. The image projector 252 is accommodated between the roof of this vehicle V and its roof lining. The latter projector is adapted to direct an image of a quantum rod light source by reflection in the direction of the edge of this windshield 241 so that the rays propagate therein by internal reflection in accordance with the basic principle shown in FIG. 1.

This windshield 241 also includes decoupling elements that deflect the light rays in the direction of the observer, namely the driver in this example.

As shown here, a virtual image I1 is formed in front of the vehicle, for example, corresponding to an indication of arriving at a destination in 500 metres (m), for example.

Here the decoupling elements are arranged so that only the driver can see this image I1, only the driver receiving these light rays. A plurality of image projectors may be envisaged, however, coupled to the windshield 241 so that some images are visible to other passengers in the vehicle V.

In accordance with a third embodiment, the display system 340 uses the rear window 341 as the screen 41 of this display system 340. An image projector 352 is arranged at the bottom of the rear window 341, for example above the trunk of the vehicle V, so as to project an image of a quantum rod source into the edge surface of the rear window 341 so that the light propagates therein and exits therefrom in accordance with the basic principle shown in FIG. 1.

Here this display system 340 is particular in that before encountering the eye of the observer the light rays are directed, thanks to the arrangement of the decoupling elements of the rear window 341, in the direction of a rear view mirror 343, which in this example is fixed to the roof lining of the vehicle. A virtual image I4 is therefore formed in front of the rear window 341, relative to the position of the observer, i.e. to the rear of the vehicle V. The observer therefore sees the virtual image I4 in the rear view mirror 343 as being formed to the rear of the vehicle.

For example, this can be an image I4 indicating that the safe following distance is not being complied with by the vehicle following the vehicle V, thus directing the attention of the driver to decisions to be taken in the event of braking, in particular.

In this example, as indicated above, the roof lining 79 includes at least one emitter adapted to send a control signal to the receiver 153 in the pair of eyeglasses 140.

The roof lining may be coupled to a speed sign detection device that communicates with a computer, here in the roof lining. The computer controls the emitter in the roof lining which sends a control signal, for example a Wi-Fi signal, that is received by the receiver 153 in the pair of eyeglasses 140. The latter receiver 153 is connected to the control device of the image projector 152 which, when it receives this signal, associates, for example by means of a processor, the configuration of the activated luminous zones of the quantum rod source required to form on that quantum rod source the pattern corresponding to the corresponding speed limit. The image projector 152 therefore directs all the rays forming this pattern into the lens 141, which directs the rays toward the driver, who therefore observes in front of them a virtual image I3 corresponding to the speed limit concerned.

Likewise, the computer may be coupled to a sensor of the distance from the vehicle V to a following vehicle, determine if that distance is below a given threshold and then send the control signal controlling the luminous zone so as to form the virtual image I4 to the rear of the vehicle V.

The image projectors, notably that 252 of the display system 240 including the windshield 241, may include a light source sufficiently large to display different information, for example the first virtual image I1 indicating arrival in 500 m and a second virtual image I2 indicating route information indicating a turn to the left.

The computer may communicate with a navigation system of the vehicle V to send the control signal corresponding to these first and second virtual images I1 and I2.

The devices sending the control signal to the control device of the quantum rod light source are not necessarily in the roof lining 79, but may for example be located at the level of the dashboard or anywhere else in the vehicle, provided that they can communicate with this control device.

Likewise, the computer may be integrated into the vehicle or into the vision device.

The control device 29 may include a memory containing a data bank of images associated with codes so that when the control signal sent by other devices, such as the speed limit detector, is received and corresponds to one of those codes the control device 29 activates the light source S so as to form the luminous pattern M associated with that code.

Other embodiments of display systems are possible and in particular vision devices other than a pair of eyeglasses 140 may be envisaged.

For example, in FIG. 7 a display system according to a fourth embodiment includes a vision device 440 that forms a monocular with a lens 441 carried by a headband 442 intended to be worn on the head of the user.

The image projection device 452 is housed in this headband 442 and projects the images into this monocular 441, in accordance with the basic principle shown in FIG. 1.

FIG. 8 represents a variant of FIG. 8. Here the display system 540 according to a fifth embodiment does not include a vision device that can be worn by the user because the lens 541 intended to face the eye of the observer is carried by the roof lining of the vehicle.

An articulated arm 542 fixed to the roof lining of the vehicle holds this lens 541. An image projector 552 is connected to the upper part of the lens 541 and coupled with the latter in accordance with the basic principle shown in FIG. 1. It is therefore an articulated device that can be folded against the roof of the passenger compartment or lowered in front of the eye of the driver.

As shown in FIG. 9, according to a sixth embodiment of the invention the vision device may equally be a protective helmet 640 for a motor vehicle driver or motorcycle rider. In this case, it is the visor 641 of the helmet 640 that forms the screen 41 of the display system.

The portion of the helmet 342 protecting the lower jaw may include an image projector 652 adapted to direct the light rays coming from the light source into the visor 641 to form the virtual image I in front of the visor 641 in accordance with the basic principle shown in FIG. 1.

1. A display system comprising:
an at least partly transparent and at least partly reflective screen; and
an image projector including a light source including submillimetre-size light-emitting quantum rods, the set of quantum rods being configured to emit a luminous pattern,
wherein the projector and the screen cooperate to form a virtual image of the luminous pattern by the screen.

2. The display system according to claim 1, wherein the screen has a light transmission coefficient of at least 20%.

3. The display system according to claim 1, wherein the screen has two extended faces separated by an edge surface, the image projector being adapted to direct the light rays forming the source image toward that edge surface, the screen including decoupling elements and being such that these light rays propagate within the thickness of the screen as far as decoupling elements that deflect the light rays out of the screen through one of its extended faces.

4. The display system according to claim 1, wherein the quantum rods are distributed in different luminous zones arranged to form the luminous pattern.

5. The display system according to claim 4, wherein the luminous zones are activated selectively.

6. The display system according to claim 5, wherein the luminous zones are distributed in luminous groups, each of these groups including at least two luminous zones, and in each luminous group each luminous zone is adapted to emit light rays of a colour different from that of the light rays that the other luminous zones of that luminous group are adapted to emit.

7. The display system according to any claim 1, wherein the screen is a vehicle screen.

8. The display system according to claim 1, wherein said system includes a vision device including said screen and at least one retaining element supporting said screen, the retaining element or elements being adapted to retain the vision device on the head of a user so that the screen is arranged in front of at least one eye of the user.

9. The display system according to claim 8, wherein the image projector is on the retaining element or one of the retaining elements.

10. The display system according to claim 8, wherein the screen has a front face and a rear face separated by an edge surface and in which the image projector is adapted to direct the light rays forming the source image toward that edge surface, the image projector including coupling elements and being such that these rays propagate within the thickness of the screen as far as decoupling elements that deflect the light rays out of the screen through its rear face.

11. The display system according to claim 8, wherein the retaining element includes a device for controlling the light source so as to form the luminous pattern.

12. The display system according to claim 11, wherein the retaining element includes a signal receiver.

13. The display system according to claim 8, wherein said vision device is chosen from:
a helmet the visor of which forms said screen and the protective part of which forms said retaining element,
a pair of goggles of which at least one lens forms said screen and the frame of which forms said retaining element,
a vision mask the transparent mask of which forms the screen and the frame of which forms said retaining element,
a monocular the lens of which forms said screen and the frame of which forms said retaining element.
